(19) United States
(12) Patent Application Publication
(10) Pub. No.: US 2025/0292093 A1
(43) Pub. Date: Sep. 18, 2025

(54) HUMAN-AI COLLABORATIVE PROMPT ENGINEERING

(71) Applicant: International Business Machines Corporation, Armonk, NY (US)

(72) Inventors: Muntasir WAHED, Blacksburg, VA (US); Bing ZHANG, San Jose, CA (US); Daniel GRUHL, San Jose, CA (US); Chad Eric DELUCA, Morgan Hill, CA (US); Hirenkumar Ashokbhai THUMMAR, Santa Clara, CA (US); Shubhi ASTHANA, San Jose, CA (US); Alfredo ALBA, Morgan Hill, CA (US); Linda Ha KATO, San Jose, CA (US); Steven R. WELCH, Gilroy, CA (US)

(21) Appl. No.: 18/602,868

(22) Filed: Mar. 12, 2024

(51) Int. Cl. G06N 3/0895; G06N 3/045

(52) U.S. Cl. CPC G06N 3/0895; G06N 3/045

(57) ABSTRACT

Embodiments herein describe techniques for optimizing prompts describing tasks for a large language model (LLM), to enable effective and efficient operations to optimize prompt generation and selection for various tasks in LLMs through human-AI collaboration. In an embodiment, a computing system applies a set of candidate prompts to the LLM, evaluates responses to the candidate prompts received from the LLM and calculates a pairwise similarity matrix of responses based on the received responses to the candidate prompts. The computing system evaluates the pairwise similarity matrix to determine whether or not to present a prompt to receive a user feedback input. The described techniques can enable enhanced processing speed, reducing an overall computer system time typically required for implementing optimized prompt generation, and enhancing performance of the computing system executing the LLM.

### BACKGROUND

The present invention relates to data processing field, and more specifically, to methods, systems, and computer program products for efficiently implementing prompts describing tasks for large language models (LLMs).

A prompt is natural language text describing a task that an Artificial Intelligence (AI) model should perform. Prompt engineering is the process of structuring text that can be interpreted and understood by a generative artificial intelligence (AI) model, such as an LLM. LLMs can enable high performance in a diverse range of tasks, for example, image captioning, question answering, and text classification; however, the performance of the LLMs directly depends on the choice of prompts, i.e., the description of a task. For example, small changes in the prompt can lead to significantly different results and can include some unsatisfactory results. A need exists for enhanced systems and techniques for implementing prompts efficiently and effectively for LLMs.

### SUMMARY

Embodiments of the present disclosure are directed to methods, systems, and computer program products for optimizing prompts describing tasks for large language models.

According to one embodiment of the present disclosure, a non-limiting computer implemented method is provided. The method comprises obtaining a plurality of previously used prompts; applying a set of candidate prompts to a large language model based on the plurality of previously used prompts; receiving responses to the candidate prompts from the large language model; calculating, based on the received responses, a pairwise similarity matrix; and determining, based on the pairwise similarity matrix, to present a prompt to receive a user feedback input.

Other disclosed embodiments include a computer system and computer program product for optimizing prompts describing tasks for large language models, implementing features of the above-disclosed method.

### BRIEF DESCRIPTION OF THE DRAWINGS

FIG. 1 is a block diagram of an example computer environment for use in conjunction with one or more disclosed embodiments;

FIG. 2 is a block diagram of an example system for implementing prompts describing tasks for LLMs of one or more disclosed embodiments;

FIGS. 3A and 3B together provide a flow chart of example operations of an example method for implementing prompts describing tasks for LLMs of one or more disclosed embodiments;

FIG. 4 is a flow chart of example similarity metric processing operations of an example method for implementing prompts describing tasks for LLMs of one or more disclosed embodiments;

FIG. 5 is a flow chart of example human expert feedback processing operations of an example method for implementing prompts describing tasks for LLMs of one or more disclosed embodiments; and

FIG. 6 is a flow chart of an example method for implementing prompts describing tasks for LLMs of one or more disclosed embodiments.

### DETAILED DESCRIPTION

Embodiments herein describe techniques for optimizing prompts describing tasks for LLMs, to enable effective and efficient operations to optimize prompt generation and selection for various tasks in LLMs through human-AI collaboration. Disclosed embodiments implement robust, effective, and efficient prompt optimization for LLMs for various diverse tasks. In an embodiment, a computing system applies a set of candidate prompts to the LLM, and evaluates responses to the candidate prompts received from the LLM. In an embodiment, the computing system calculates a pairwise similarity matrix of responses based on the received responses to the candidate prompts, and evaluates the pairwise similarity matrix to determine whether or not to present a prompt to receive a user feedback input. For example, the computing system identifies response similarity of responses for a first prompt and responses for a second prompt, compares the response similarity of the responses for the first and the second prompts with a defined threshold value; and presents the prompt to receive the user feedback input when the response similarity is less than the defined threshold value. When the response similarity are substantially different, a prompt advantageously is presented to receive a user feedback input; otherwise, when the response similarity are the same or nearly the same user feedback is not needed. For example, receiving responses to the candidate prompts from the LLM can take over 20 seconds or potentially several minutes, while human annotation typically takes 1-2 seconds on average. The described techniques can enable enhanced processing speed, reducing an overall computer system time used for implementing optimized prompt generation over traditional baseline prompt generation arrangements. In this manner, the embodiments herein can improve the performance of the computing system executing the LLM.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

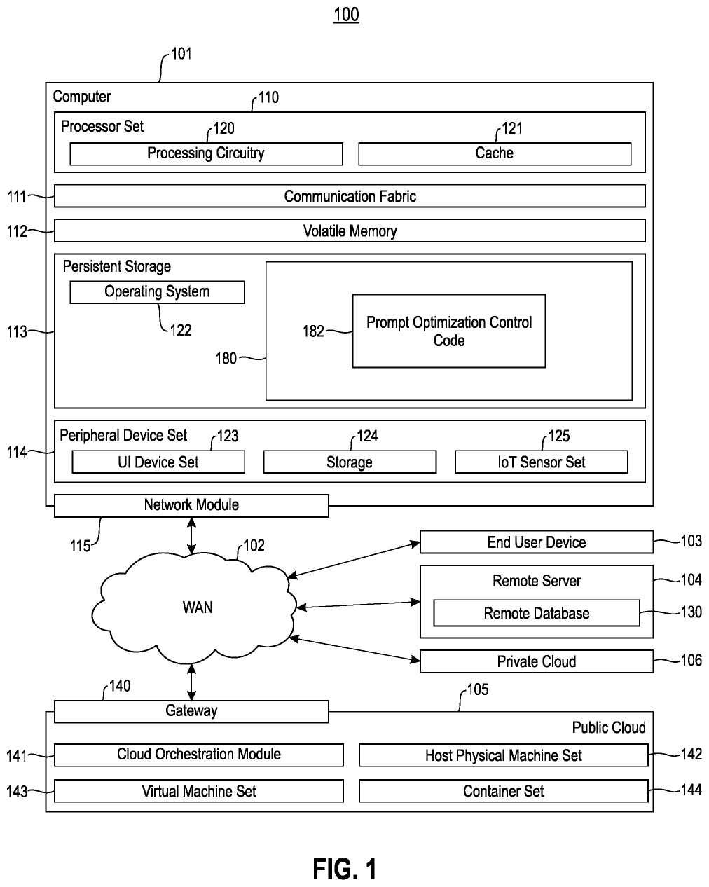

Referring to FIG. 1, a computing environment 100 contains an example of an environment for the execution of at least some of the computer code involved in performing the inventive methods, such as a Prompt Optimization Control Component 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In an embodiment, a computing system provides inexpensive and efficient methods of boosting LLM performance to provide enhanced value across a wide array of downstream tasks. Disclosed embodiments leverage a small language model to generate and refine prompts, tailored for a specific task, where the prompts are scored according to the output from a large language model. When the output meets predefined criteria, the computing system accepts the output as successful. Otherwise, the computing system continues the prompt optimizing process for further enhancement. The disclosed dynamic, iterative process can ensure that the computing system generates effective prompts for each specific task, thereby maximizing the potential of a given large language model. The disclosed dynamic, iterative process does not require labeled data, and does not employ an external knowledge base. By incorporating expert human feedback, the computing system refines the prompt optimizing process, reducing the risk of ‘false prompts’ and enhancing overall performance. The disclosed strategic combination of AI and human ingenuity allows the computing system to discover and optimize effective prompts, enabling a myriad of effective prompts describing tasks across multiple various applications.

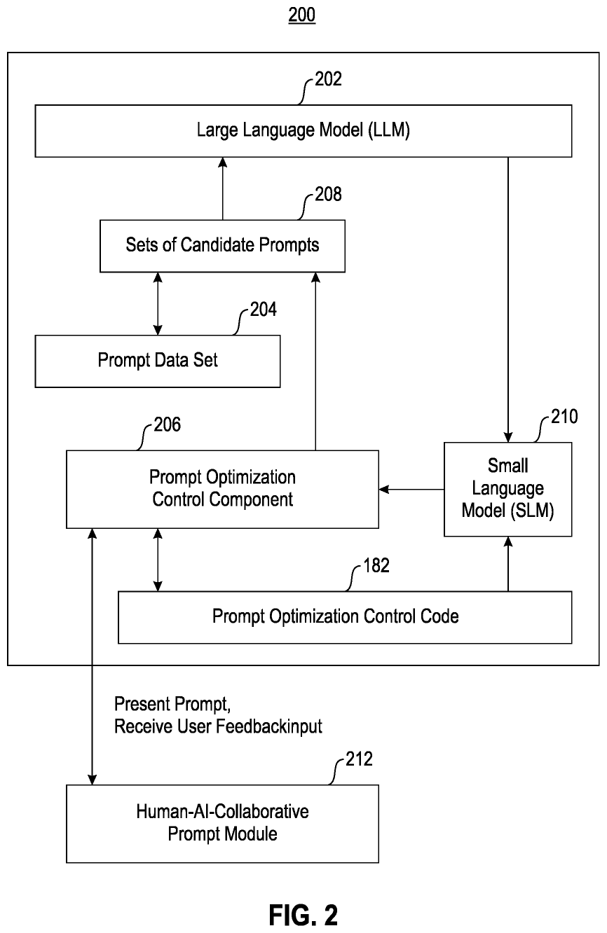

FIG. 2 illustrates an example system 200 for implementing prompts describing tasks for LLMs of one or more disclosed embodiments. System 200 can be used in conjunction with the computer 101 and cloud environment of the computing environment 100 of FIG. 1 with the Prompt Optimization Control Code 182 for optimizing prompts of disclosed embodiments. In a disclosed embodiment, system 200 enables effective and efficient optimization of prompts describing tasks for LLMs.

In an embodiment, system 200 includes at least one LLM 202 of any suitable implementation. System 200 includes a prompt data set 204 storing previously used prompts, and updated prompts received from prompt optimization operations. System 200 includes a prompt optimization control component 206 for optimizing a new set of candidate prompts 208 applied to the LLM 202 at each of multiple prompt generation iterations. System 200 includes a small language model (SLM) 210 that receives responses for candidate prompts 208 from the LLM 202 for each set of candidate prompts at each of multiple prompt generation iterations to generate optimized prompts for the LLM. In a disclosed embodiment, SLM 210 automatically generates prompts for the LLM 202 with the prompt optimization control component 206 that are optimized based of the feedback responses for candidate prompts 208 from the LLM. System 200 includes a human-AI-collaborative prompt module 212 for presenting one or more prompts to receive an input from a human, e.g., user or subject matter expert (SME), providing a manual input.

In a disclosed embodiment, system 200 obtains (e.g., randomly samples) a set of previously used prompts stored in a prompt data set 204, and for each of the previously used prompts, generates a set of candidate prompts to apply to the LLM 202. System 200 receives responses to the candidate prompts from the LLM 202 and inputs the responses to the SLM 210, which generates a new set of candidate prompts based on input responses. System 200 optimizes the candidate prompts based on the responses from the LLM 202 using the SLM 210 and the prompt optimization control component 206 of disclosed embodiments. In an embodiment, the LLM 202 and SLM 210 can be implemented by various available language models, such as, open-Source LLMs, ChatGPT by OpenAI, or LLAMA by Meta, and the SLM can be implemented for example by ChatGPT, and the like.

In an embodiment, system 200 calculates a pairwise similarity matrix based on the responses to evaluate the candidate prompts, for example using the SLM 210 and the prompt optimization control component 206 of disclosed embodiments. In a disclosed embodiment, system 200 evaluates the pairwise similarity matrix and determines whether it may be useful to involve a human who can accept or reject the prompts discovered by the SLM 210 based on responses to candidate prompts by the LLM 202 in the prompt optimizing process. System 200 determines whether to present such prompts discovered by the SLM 210 to a human using the human-AI-collaborative prompt module 212 based on the evaluating responses for candidate prompts including the initial set of candidate prompts. System 200, using the human-AI-collaborative prompt module 212, presents prompts and injects user feedback input into the prompt optimizing process of disclosed embodiments, and advantageously improves performance, for example by reducing noisy feedback and making the prompt optimization smoother as compared to traditional baseline prompt generation techniques.

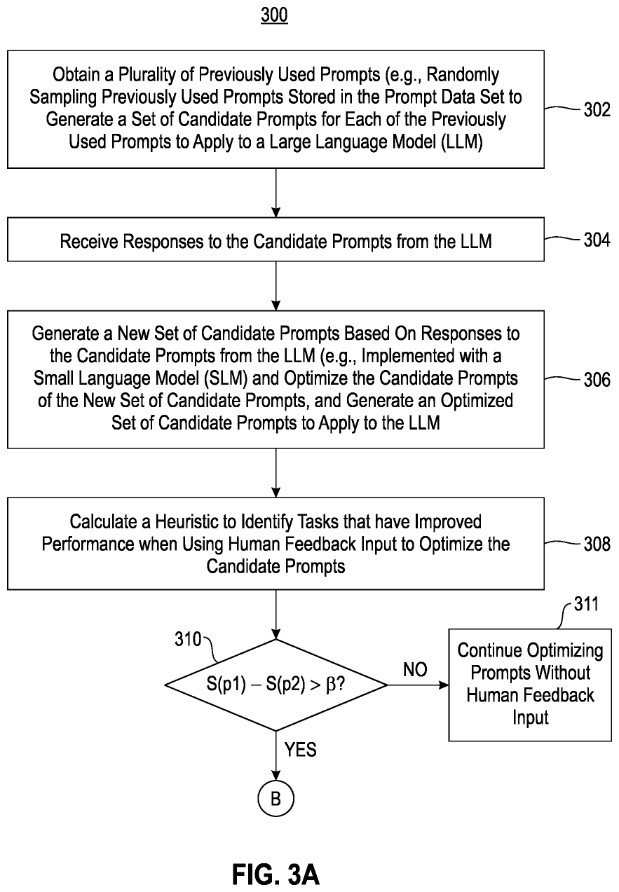

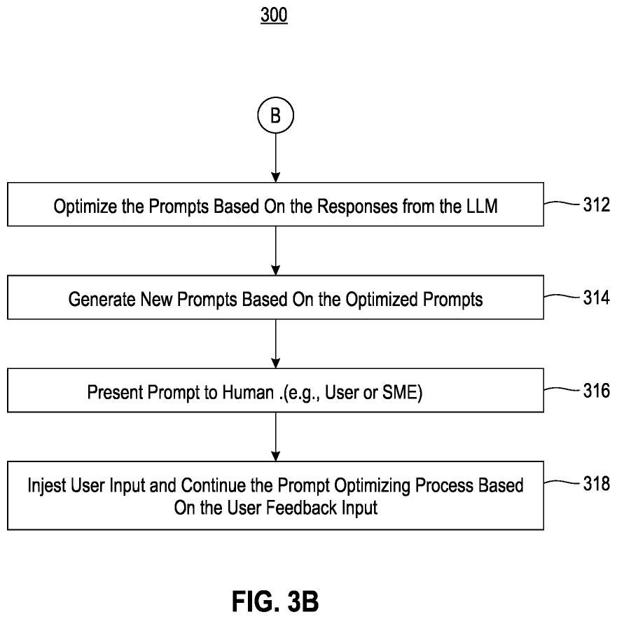

FIGS. 3A and 3B together illustrate example operations of an example method 300 for implementing prompts describing tasks for LLMs of one or more disclosed embodiments. For example, in a disclosed embodiment, method 300 is implemented by system 200 in conjunction with the computer 101 of FIG. 1 and the Prompt Optimization Control Code 182.

In FIGS. 3A, 3B, 4, 5, and 6, the same reference numbers are used for identical or similar components as used in FIG. 2. In disclosed embodiments, respective methods 400, 500, and 600 are implemented by system 200 in conjunction with the computer 101 of FIG. 1 and the Prompt Optimization Control Code 182.

At block 302, system 200 obtains a set of previously used prompts, which are used for generating candidate prompts to apply to an LLM 202. In an embodiment, system 200 randomly samples previously used prompts, for example, stored in the prompt data set 204 to receive a set of previously used prompts describing tasks, where the prompts are adapted for a given AI large language model implementing the LLM 202.

For each of the previously used prompts, system 200 generates a set of candidate prompts at block 302. At block 304, system 200 receives responses to the candidate prompts from the LLM 202 to evaluate, generate and optimize new candidate prompts. For example, responses to the candidate prompts from the LLM 202, such as the responses to an initial set of candidate prompts, and each iteration of new candidate prompts of the prompt optimizing process 300, are input to the SLM 210.

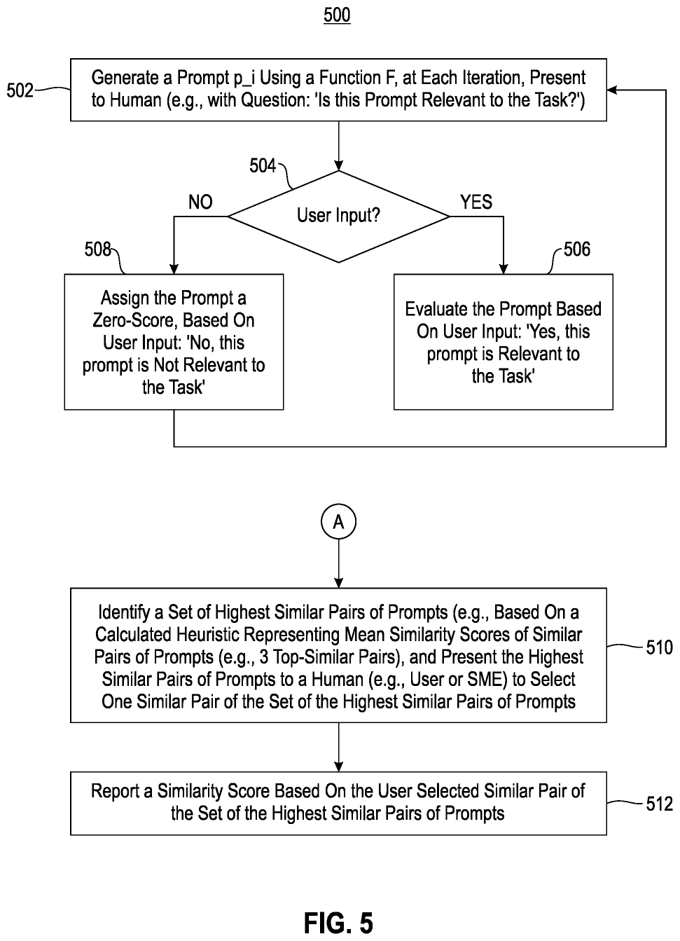

At block 306, system 200 generates a next set of candidate prompts describing tasks based on the responses to the candidate prompts from the LLM 202 (and optimizes the new candidate prompts (e.g., the generating and optimizing candidate prompts implemented with the SLM 210) to apply to the LLM 202. Zero-shot learning, few-shot learning and one-shot learning techniques can be used to allow system 200 to optimize the new candidate prompts to apply to the LLM 202. In an embodiment, system 200 evaluates the candidate prompts using a pairwise similarity matrix of responses, (e.g., using SLM 210), which is calculated based on the responses from LLM 202 to the candidate prompts, such as illustrated and described with respect to FIG. 5.

At block 308, system 200 calculating a heuristic, based on responses to candidate prompts describing tasks from LLM 202, for example to determine whether to use human feedback input to optimize the candidate prompts (e.g., using a pairwise similarity matrix of responses). For example, system 200 determines at a decision block 310 whether to use human feedback, for example, by comparing response similarity of the responses S(p1) for a first prompt and the responses S(p2) for a second prompt with a defined threshold value β. In an embodiment, at block 311 system 200 continues optimizing prompts without human when the result of the compared responses is greater than or equal to the defined threshold value β, for example represented by:

S(p1)−S(p2)>β

Otherwise, when the result of the compared responses is less than to the defined threshold value β, operations continue following B at block 312 in FIG. 3B to involve a human in the prompt optimizing loop.

Referring to FIG. 3B, at block 312, system 200 optimizes the prompts based on the responses to the candidate prompts from the LLM 202. At block 314, system 200 generates new prompts based on the optimized prompts. At block 316, system 200 presents a prompt to a human (e.g., user or SME). For example, system 200 presents the prompt to receive user feedback input to accept or reject the prompt, or for example, to select one similar pair of prompts of a plurality of highest similar pairs of prompts. At block 318, system 200 injests a user feedback input to a given prompt and continues optimizing candidate prompts based on the received user feedback input.

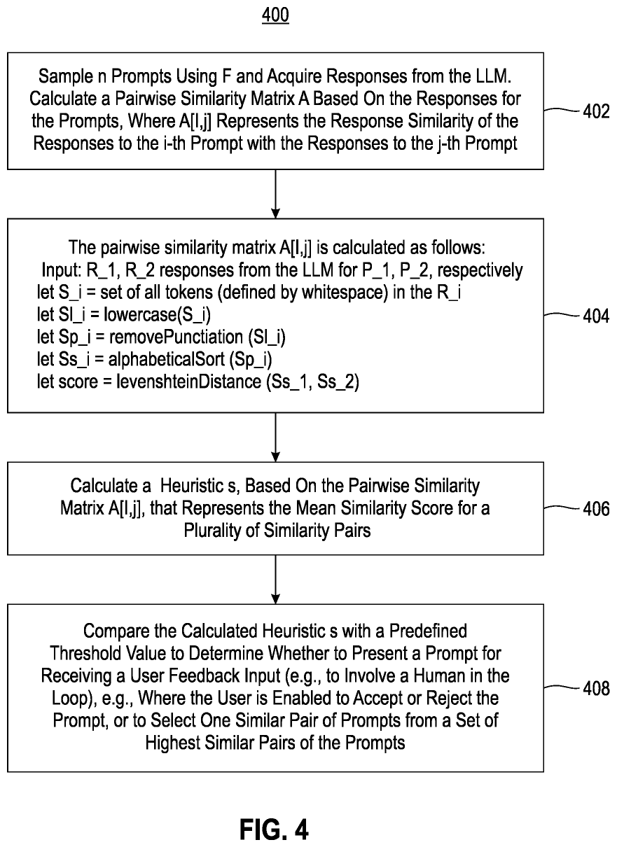

FIG. 4 illustrates example similarity metric processing operations of an example method 400 for implementing prompts describing tasks for LLMs 202 of one or more disclosed embodiments. At block 402, system 200 samples n prompts using a defined function F and acquire responses for the candidate prompts, and calculates a pairwise similarity matrix A[i, j] of responses based on the responses for the candidate prompts, where the pairwise similarity matrix A[i, j] represents the response similarity of the responses for the i-th prompt with the responses for the j-th prompt. At block 404, for example system 200 calculates the pairwise similarity matrix A[i, j] as follows:
Input: R_1, R_2, responses from the LLM for P_1 and P_2 respectively
let S_i=set of all tokens (defined by whitespace) in the R_i
let Sl_i=lowercase(S_i)
let Sp_i=removePunctiation(Sl_i)
let Ss_i=alphabeticalSort(Sp_i)
let score=levenshteinDistance(Ss_1, Ss_2)

For example at block 404, a set of all tokens defined by white space in R_1 and a set of all tokens defined by a white space in R_2 are obtained, lower case is set, punctuation is removed, alphabetically sorted, and a Levenshtein distance is identified, which represents the edits needed to change from the first set to the second set. It should be understood that processing metrics shown at block 404 for calculating the pairwise similarity matrix A[i, j] is illustrative only and various other similarity measures can be used. At block 406, system 200 calculates a heuristic s, based on the pairwise similarity matrix A[i, j], that represents a mean similarity score for a plurality of similar pairs of prompts. At block 408, system 200 compares the calculated heuristic s with a predefined threshold value β (e.g. heuristic s<a predefined threshold value) to determine whether to present a prompt for receiving a user feedback input.

In an embodiment, for example, system 200 determines to involve a human in the loop when the calculated heuristic s is less than the predefined threshold value β). Otherwise, optimizing prompts continues without the human based on determining that the calculated heuristic s is equal to or greater than the predefined threshold value β.

FIG. 5 is a flow chart of example human expert feedback processing operations of an example method 500 for implementing prompts describing tasks for LLMs of one or more disclosed embodiments. At block 502, system 200 generates a prompt p_i using a function F, at each iteration, and presents the prompt to a human (e.g., with question: ‘Is this prompt relevant to the task’). At decision block 504, system 200 identifies the user feedback input in response to a given prompt. At block 506, system 200 evaluates the prompt using the LLM based on the user input, ‘yes, this prompt is relevant to the task.’ Alternatively at block 508, system 200 assigns the prompt a zero-score, based on the user input, ‘no, this prompt is not relevant to the task.’ Operations return to block 502 to process the next prompts to be presented for human input, at each iteration of the prompt optimizing process.

At block 510, in response to completing an automatic prompt optimizing process indicated at A, system 200 generates a set of highest similar pairs of prompts based on a heuristic representing mean similarity scores of similar pairs of prompts discovered by system 200, such as three (3) top-similar pairs of prompts, and presents the set of highest similar pairs of prompts to a human, (e.g., the user or SME) to pick one similar pair of the set of highest similar pairs of prompts. At block 512, in response to the selected similar pair of prompts from the user input, system 200 reports a similarity score based on the user selected similar pair of prompts.

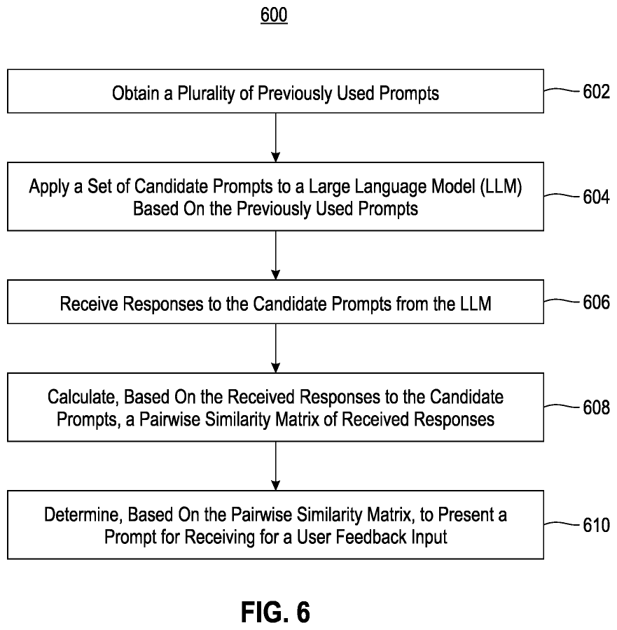

FIG. 6 illustrates features and operations of a method 600 for implementing prompts describing tasks for LLMs of one or more disclosed embodiments. At block 602, system 200 obtains a plurality of previously used prompts for a LLM. In an embodiment, system 200 obtains the plurality of previously used prompts by randomly sampling the prompt data set 204 of previously used prompts.

At block 604, system 200 applies a set of candidate prompts to the LLM based on the plurality of previously used prompts. In an embodiment, system 200 generates a set of candidate prompts based on each of the initial plurality of previously used prompts.

At block 606, system 200 receives responses to the candidate prompts from the LLM, used to evaluate the candidate prompts. In an embodiment, system 200 generates, at each iteration of an automatic prompt optimizing process, (e.g., using the SLM) 210) a set of candidate prompts based on responses to the candidate prompts from the LLM 202. In an embodiment, system 200 applies the responses to the candidate prompts from the LLM to the SLM 210, which is used to generate new candidate prompts, and optimize the prompts based on the responses from the LLM 202 (e.g., such as illustrated and described with respect to blocks 304 and 306 in FIG. 3A) . . . . In an embodiment, system 200 automatically determines when to involve human feedback to refine prompts generated by a small language model, which represents an interactive and iterative process (e.g., as described for decision block in FIG. 3A).

At block 608, system 200 calculates, based on the received responses to the candidate prompts from the LLM, a pairwise similarity matrix of received responses. In an embodiment, system 200 receives an input response pair R_1, R_2 of responses from the LLM 202 for a first prompt P_1 and a second prompt P_2 of a prompt pair, and identifies response similarity of the responses based on the input response pair R_1, R_2 of responses for the first prompt P_1 and the second prompt P_2 (e.g., as described for block 402 in FIG. 4). In an embodiment, system 200 calculates the pairwise similarity matrix A[i, j] (e.g., as described for block 404 in FIG. 4). based on the input response pair R_1, R_2 of responses for the prompt pair P_1 and P_2 of prompts, where A[i, j] represents the response similarity of the responses for the i-th prompt with the responses for the j-th prompt.

At block 610, system 200 determining, based on the pairwise similarity matrix, to present a prompt for receiving a user feedback input. In an embodiment, system 200 determines whether to use human feedback by comparing response similarity of responses for a first prompt with the responses for a second prompt with a defined threshold value, and invokes human feedback based on the comparing. In an embodiment, system 200 calculates a heuristic, based on the pairwise similarity matrix A[i, j], that represents a mean similarity score for a plurality of similar pairs of prompts and identifies a set of highest similar pairs of prompts (e.g., identifying top-3 highest similar pairs). In an embodiment, system 200 compares the calculated heuristic to a predefined threshold value β to determine whether to present a prompt to receive a user feedback input to select one similar pair of the set of highest similar pairs of prompts.

In brief summary, system 200, by integrating human feedback in accordance with disclosed embodiments can produce more contextually appropriate and nuanced prompts, enabling better performance in diverse tasks over baseline arrangements. Additionally, the disclosed human-in-the-loop methods reduce the computational and time resources required for prompt testing and optimization, by streamlining the prompt optimizing process. For example, experimental results show that methods 300, 400, 500, and 600 of disclosed embodiments achieve impressive performance improvement compared to the baseline arrangements in a variety of tasks on test sets, for example performance improvement of, informal-to-formal (27%), antonyms (3%), word unscrambling (15%), translation (9%), and the like. Additionally, a significant reduction in application program interface (API) call usage of the LLM 202, which is important because an API call on a simple LLM can take over 20 seconds, with more complex LLMs potentially taking many minutes, whereas human annotation typically takes 1-2 seconds on average.

While the foregoing is directed to embodiments of the present invention, other and further embodiments of the invention may be devised without departing from the basic scope thereof, and the scope thereof is determined by the claims that follow.

What is claimed is:

1. A method comprising:
obtaining a plurality of previously used prompts for a large language model (LLM);
applying a set of candidate prompts to the LLM based on the plurality of previously used prompts;
receiving responses to the set of candidate prompts from the LLM;
calculating, based on the received responses to the candidate prompts from the LLM, a pairwise similarity matrix of received responses; and
determining, based on the pairwise similarity matrix, to present a prompt to receive a user feedback input.

2. The method of claim 1, wherein obtaining the plurality of previously used prompts further comprises randomly sampling a stored data set of previously used prompts.

3. The method of claim 1, wherein receiving the responses to the candidate prompts from the LLM, further comprises applying the responses from the LLM for the candidate prompts as an input to a small language model (SLM) to generate a new set of candidate prompts.

4. The method of claim 3, further comprises optimizing candidate prompts of the new set of candidate prompts, and generating an optimized set of candidate prompts to apply to the LLM.

5. The method of claim 1, wherein the pairwise similarity matrix is represented by: A[i, j], and A[i, j] represents the response similarity of the responses for the i-th prompt with the responses for the j-th prompt.

6. The method of claim 1, wherein determining, based on the pairwise similarity matrix A[i, j], further comprises calculating a heuristic to identify tasks having improved performance based on using a human feedback input to optimize candidate prompts.

7. The method of claim 1, wherein determining, based on the pairwise similarity matrix, to present the prompt to receive the user feedback input further comprises identifying response similarity of an input response pair of responses for a first prompt and responses for a second prompt.

8. The method of claim 7, further comprises comparing the response similarity of the responses for the first prompt and the responses for the second prompt with a defined threshold value, and where the response similarity is less than the defined threshold value, presenting the prompt for receiving the user feedback input.

9. The method of claim 1, wherein determining, based on the pairwise similarity matrix, to present the prompt for receiving the user feedback input further comprises calculating a heuristic, based on the pairwise similarity matrix that represents a mean similarity score for a plurality of similar pairs of prompts and identify a set of highest similar pairs of prompts.

10. The method of claim 9, further comprises presenting the prompt for receiving the user feedback input to select one similar pair of prompts from the set of the highest similar pairs of the prompts.

11. A system, comprising one or more computer processors; and a memory containing a program which when executed by the one or more computer processors performs an operation, the operation comprising:
obtaining a plurality of previously used prompts for a large language model (LLM);
applying a set of candidate prompts to the LLM based on the plurality of previously used prompts;
receiving responses to the candidate prompts from the LLM;
calculating, based on the received responses from the LLM, a pairwise similarity matrix of received responses; and
determining, based on evaluating the pairwise similarity matrix, to present a prompt to receive a user feedback input.

12. The system of claim 11, wherein receiving the responses to the candidate prompts from the LLM further comprises applying the responses from the LLM for the candidate prompts as an input to a small language model (SLM) to generate a new set of candidate prompts.

13. The system of claim 12, further comprises optimizing candidate prompts of the new set of candidate prompts, and generating an optimized set of candidate prompts to apply to the LLM.

14. The system of claim 11, wherein determining, based on the pairwise similarity matrix, to present the prompt for receiving the user feedback input further comprises identifying response similarity of an input response pair of responses for a first prompt and responses for a second prompt.

15. The system of claim 14, further comprises comparing the response similarity of the responses for the first prompt and the responses for the second prompt with a defined threshold value, and presenting the prompt for receiving the user feedback input when the response similarity is less than the defined threshold value.

16. A computer program product comprising a computer-readable storage medium having computer-readable program code embodied therewith, the computer-readable program code executable by one or more computer processors to perform an operation comprising:
obtaining a plurality of previously used prompts for a large language model (LLM);
applying a set of candidate prompts to the LLM based on the plurality of previously used prompts;
receiving responses to the candidate prompts from the LLM;
calculating, based on the received responses from the LLM, a pairwise similarity matrix of received responses; and
determining, based on evaluating the pairwise similarity matrix, to present a prompt to receive a user feedback input.

17. The computer program product of claim 16, wherein receiving the responses to the candidate prompts from the LLM further comprises applying the responses from the LLM for the candidate prompts as an input to a small language model (SLM) to generate a new set of candidate prompts.

18. The computer program product of claim 17, further comprises optimizing candidate prompts of the new set of candidate prompts, and generating an optimized set of candidate prompts to apply to the LLM.

19. The computer program product of claim 16, wherein determining, based on the pairwise similarity matrix, to present the prompt to receive the user feedback input further comprises identifying response similarity of an input response pair of responses for a first prompt and responses for a second prompt.

20. The computer program product of claim 16, further comprises comparing the response similarity of the responses for the first prompt and the responses for the second prompt with a defined threshold value; and presenting the prompt to receive the user feedback input when the response similarity is less than the defined threshold value.
